(19) United States
(12) Patent Application Publication
(10) Pub. No.: US 2013/0193392 A1
(43) Pub. Date: Aug. 1, 2013

(54) Ramp

(71) Applicant: Frank McGinn, Alvin, TX (US)

(72) Inventor: Frank McGinn, Alvin, TX (US)

(21) Appl. No.: 13/360,977

(22) Filed: Jan. 30, 2012

(51) Int. Cl. B66F 3/24

(52) U.S. Cl. 254/93 R

(57) ABSTRACT

The invention is directed towards a lifting device for automobiles or other wheeled vehicles. The lifting device comprises a ramp with the ability for the device to raise into the air after the vehicle has driven up the ramp.

### BACKGROUND

Maintaining vehicles has always presented the problem of accessing the vehicle's undercarriage. Solving this problem has traditionally been accomplished using a variety of techniques that fall into one or more categories: driving the vehicle over a pit or using a lift (such as a hydraulic lift) to raise the vehicle to a raised or overhead position. These types of lifting methods require costly equipment or specialized building construction. Lifting a vehicle with more modest equipment, such as equipment available to individuals usually employs a jack with jack stands or some type of ramp. Ramps turn out to be convenient for small shops or individuals because they effectively lift the vehicle and are typically affordable. But the geometry of a ramp requires that the vehicle clear the ramp such that the vehicle wheels contact the lower edge of the ramp before any other part of the vehicle contacts the ramp. Unfortunately, for vehicles that are low to the ground, this presents a problem because the available space to fit the ramp either allows only a small amount of total lift height or requires a very long ramp with a low incline angle to avoid low vehicle parts.

What is needed is a ramp-type lift that is compact, but also allows a reasonably sized vehicle be lifted off of the ground.

### SUMMARY

In an aspect of the invention, the device has a ramp portion and a raising portion that work together to raise one or more wheels of the vehicle off of the ground. The raising portion can be actuated by any number of well-known actuators such as hydraulic actuators, pneumatic actuators, scissor mechanism, or other types of actuators.

In examples that use scissor mechanisms, some embodiments choose a pair of scissor mechanism connected with spacing rods. In some embodiments, a pair of spacing rods located at an end of the scissor mechanism each contain at least one threaded hole oriented such that a threaded rod can engage both threaded holes. In some of these embodiments, a motor connects to the threaded rod to provide a motive force to the rod. When the rod is rotated, the scissor mechanism raises or lowers. The motor can operate off of AC or DC current.

The device is designed such that it acts on at least one wheel of the vehicle.

In some embodiments, the device contains two or more ramp-lifting portions. This facilitates raising two or more wheels at a time.

### BRIEF DESCRIPTION OF FIGURES

FIG. 1 is a three-dimensional view of a ramp according to the invention shown in the closed position.

FIG. 2 is a cutaway view of the ramp according to the invention shown in an open position.

FIG. 3 is a cutaway drawings of the ramp of the invention shown with the top piece rotated out to reveal an internal scissor mechanism.

### DETAILED DESCRIPTION

The following description of several embodiments describes non-limiting examples that further illustrate the invention. All titles of sections contained herein, including those appearing above, are not to be construed as limitations on the invention, but rather they are provided to structure the illustrative description of the invention that is provided by the specification.

Unless defined otherwise, all technical and scientific terms used in this document have the same meanings as commonly understood by one skilled in the art to which the disclosed invention pertains. The singular forms a, an, and the include plural referents unless the context clearly indicates otherwise. Thus, for example, reference to “fluid” refers to one or more fluids, such as two or more fluids, three or more fluids, etc.

The features, aspects, and advantages of the invention will become more apparent from the following detailed description, appended claims, and accompanying drawings.

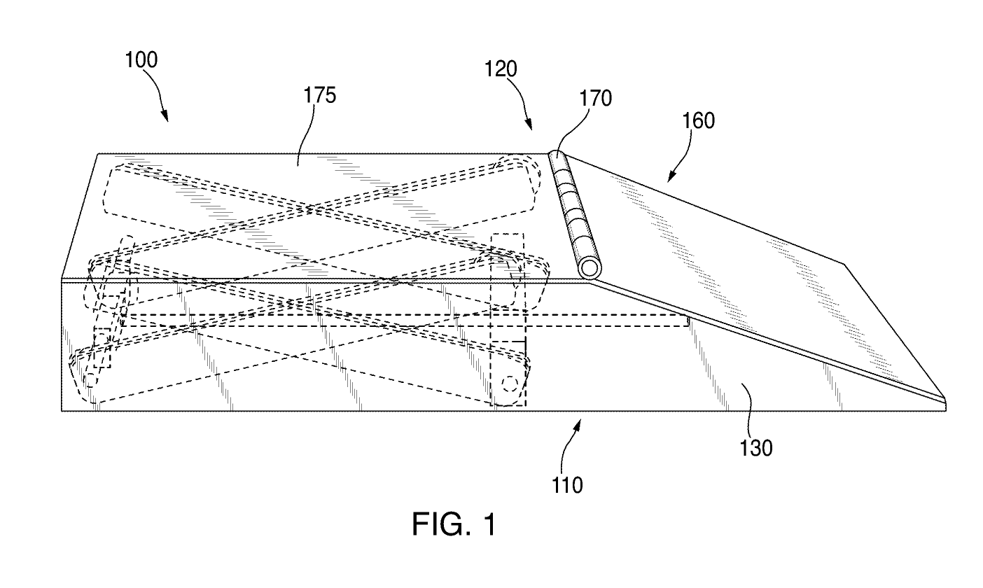

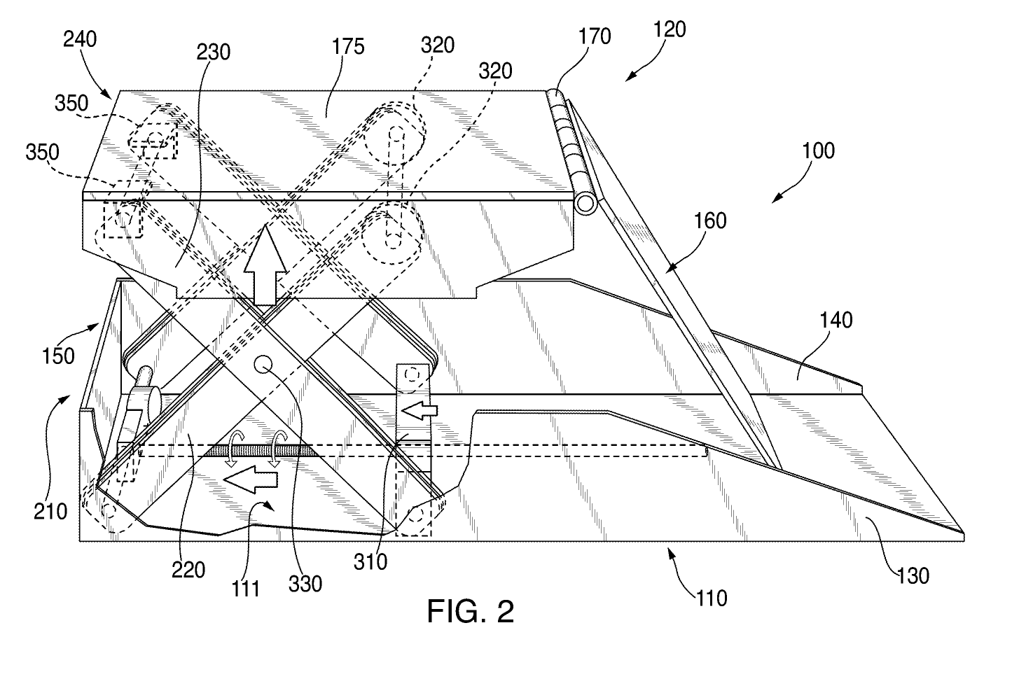

As shown in FIG. 1 and FIG. 2, device 100 comprises a base 110 and a platform 120. Base 110 comprises a base front 130, a base back 140 (FIG. 2), and a base side 150 (FIG. 2).

Base front 130 is substantially the same as base back 140 and both can be a single piece or multiple pieces. Base front 130 is described below as if having been mentally divided into two sections. One section is a long rectangular section with the long axis disposed similarly to base 110. In the current embodiment, the other section is substantially a right triangle arranged such that the triangle's hypotenuse is disposed to align with a portion of platform 120. Thus, in the current embodiment, this second section of base front 130 (or base back 140) is constructed as a triangle so that base front 130 and base back 140 do not extend above platform 120. But other embodiments are envisioned in which base front 130 or base back 140 do not contain triangular sections. In such embodiment, base front 130 or base 140 may extend beyond or above platform 120. One possible constraint on such embodiments is that base front 130 and base back 140 should not interfere with a vehicle's tires or wheels during operation of device 100 as will be discussed more fully below.

In the current embodiment, base side 150 is disposed between base front 130 and base back 140 and optionally connected to them along their adjacent edges. Base front 130, base back 140, and base side 150 are disposed around base bottom 111 and connected along the edges shared pairwise between base bottom 111, and base side 150, base front 130, and base back 140, respectively.

The connections between the various components of base 110 described above can employ screws, bolts, nuts, adhesives, brazing, welding, silver soldering, or some other joining method as known to those of ordinary skill in the art.

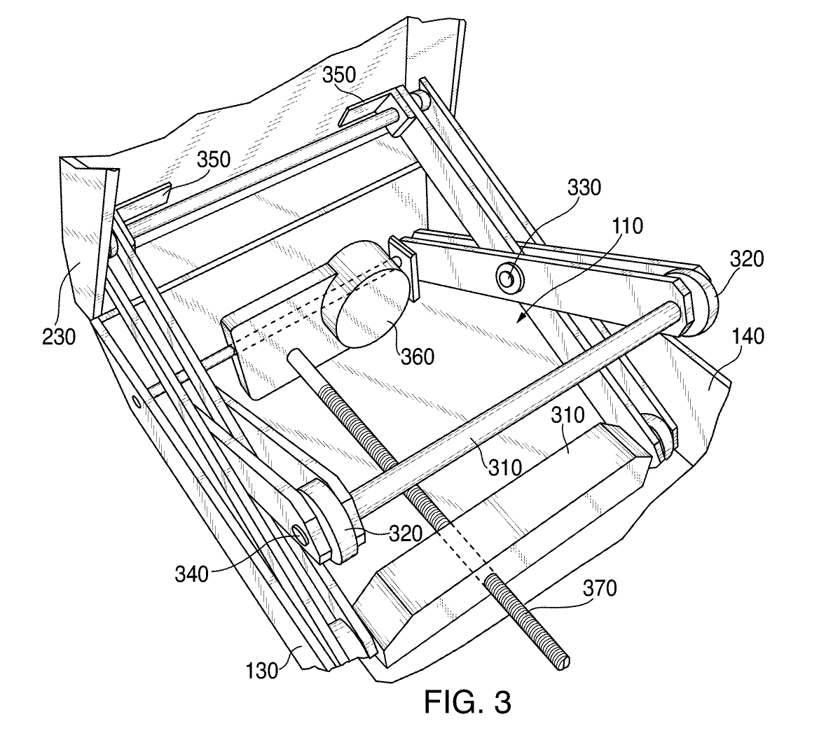

In the current embodiment, device 100 comprises an internal scissor mechanism 210 that facilitates lowering and raising platform 120. As seen in FIG. 2 and FIG. 3, scissor mechanism 210 comprises scissor arms 220, spacers 310, bearing wheels 320, pivot points 330, hinge points 340, hinge brackets 350, drive motor 360, and threaded drive rod 370. In some embodiments, scissor arms 220 are rectangular or semi-rectangular. In the current embodiment, scissor mechanism 210 comprises eight scissor arms 220—two sets with each of the sets comprising four interleaved scissor arms 220. The members of each set are connected at pivot point 330. Pivot point 330 serves as a connection point for each set of interleaved scissor arms 220. The connection between spacers 310 and scissor arms 220 can be through a rivet, a press-fit rod, a nut-and-bolt combination or any other rotatable connection method known to those of ordinary skill in the art.

Each set of interleaved scissor arms 220 connects to the other through a multiplicity of spacers 310. The current embodiment employs four spacers 310, but some embodiments using three or fewer spacers 310 are envisioned. Spacers 310 need not have the same shape and spacers 310 may serve purposes other than fixing the arrangement between the sets of scissor arms 220. For example, one spacer 310 mounted toward base 110 mounts drive motor 360 in the current embodiment. It also mounts scissor mechanism 210 to base 110. Another spacer 310 mounted toward base 110 comprises a threaded hole to receive the threaded drive rod 370. Additionally, spacers 310 can serve as an axle 340 for a bearing wheel 320. (Alternatively, a separate axle 340 could be mounted in the end of spacers 310 in some embodiments.)

Scissor mechanism 210 also attaches to platform 120. On the end of platform 120, one of spacers 310 mounts bearing wheels 320 and one of spacers 310 mounts to platform 120 through an L-shaped hinge bracket 350.

As an alternative to bearing wheels 320, some embodiments arrange an end of at least one scissor arm 220 to bear against the top of base bottom 111 or the bottom of platform 120.

The end of scissor arm 220 can be rounded to provide a bearing surface or can be machined to mate with a separate, fixed piece that bears on base bottom 111 or platform 120. For instance, a piece of teflon or other polymer can be machined to attach to scissor arm 220 and bear on base bottom 111 or platform 120.

In some embodiments, bearing wheel 320 or end of scissor arm 220 (with or without a separate-fixed piece) rides in a track or on a specially prepared surface of base bottom 111 or platform 120. This is especially useful when base bottom 111 or platform 120 is constructed out of a material softer than bearing wheels 320 or the various ends of scissor arms 220.

As an alternative to using eight scissor arms 220, some embodiments use more or fewer scissor arms 220: as few as one scissoring component comprising two scissor arms 220; two sets of scissoring portions with two scissor arms 220 per set; three or more sets of scissoring portions each containing two or more scissor arms; and other embodiments within the ability of one of ordinary skill in the art.

FIG. 1, FIG. 2, and FIG. 3 show device 100 in which scissor mechanism 210 comprises a pair of scissoring components, each scissoring component contains a single pivot point according to the figures. But other embodiments exist containing scissoring components with two or more pivot points.

The current embodiment comprises platform 120 connected to scissor mechanism 210 through an L-shaped hinge bracket 350. One leg of the L comprises a hole through which spacer 310 from scissor mechanism 210 passes. The other leg of the L attaches to the underside of platform 120. The attachment can be by welding, brazing, silver soldering, bolting, gluing using an adhesive, or any other suitable method as known to those of ordinary skill in the art taking into account the nature of the materials to be joined.

Platform 120 comprises lifting surface 175 and ramp portion 160 optionally comprising a movable connection. In the current embodiment, lifting surface 175 and ramp portion 160 are movably connected through hinge 170. In various other embodiments, this movable connection can be formed in any number of ways as known to those of ordinary skill in the art. For example, a flexible section of material could substitute for the hinged portion. Furthermore, some embodiments exists in which lifting surface 175 and ramp portion 160 are integral with each other taking the form of a single plane or of two angled planes intersecting at a line, which could be co-linear with hinge 170 in a hinged embodiment.

As seen in FIG. 2, platform 120 additionally comprises platform front 230, platform back (not shown), and platform side 240. Platform front 230 and platform back (not shown) are substantially rectangular, with the bottom edges mitered to avoid pieces of scissor lift mechanism 210 particularly when device 100 is retracted.

Platform front 230, platform back (not shown), and platform side 240 connect to platform 120 using connection methods discussed above for base 110. In some embodiments, lifting surface 175 comprises edges around platform front 230, platform back, and platform side 240 to help locate or center the vehicle wheels correctly in relation to platform 120. In these or in other embodiments, what would be the front and what would be that back of lifting surface 175 has a pushed-up portion that serves as a bump to help correctly locate the vehicle wheels. In these or other embodiments, lifting surface 175 is in fact upwardly curved such that the vehicle wheels rest in the curve, which helps correctly locate the vehicle wheels and platform 120.

The base may contain holes for mounting electrical, fluid, hydraulic, or pneumatic pass-throughs or fittings. These are not shown in these figures.

While the described device 100 comprises structural components constructed out of metals such as aluminum plate, any material with sufficient strength is likewise suitable for device 100. For instance, base 110 may be constructed out of other metal plate, metal castings, metal forgings, metal stampings, wood, plastic, or a plastic-fiber composite. Alternatively, base 110 can be molded as a single piece. In another embodiment, lifting surface 175, platform front 230, platform back, and platform side 240 are molded to be integral with one another with scissor mechanism 210 bolted to the bottom of platform 120.

In some of these embodiments, contact points are greased.

In some embodiments, threaded rod 370 is attached to motor 360 or motor 360 connected to one or more gears (gear motor). In various embodiments, motor 360 is operated using alternating or direct current. In some embodiments, motor 360 operates at 3 or greater volts, 10 or greater volts, 20 or greater volts, 110 or greater volts, 120 or greater volts, 200 or greater volts, 220 or greater volts, or 240 or greater volts. In some embodiments, the nominal operating voltage is 6 VDC, 12 VDC, 24 VDC, 32 VDC, 110 VAC, 120 VAC, 208 VAC, 220 VAC, or 240 VAC. When alternating current is used, the current can be single or multiple phases such as three phases. In some embodiments, the motor is a stepper motor. The motor can be controlled manually or automatically and can have provisions to enable it to coordinate its movement with another motor such as another motor on the same device 100 or a different instance of device 100.

Some embodiments dispense with threaded drive rod 370 and instead use a pneumatic or hydraulic lifting device situated between the components of scissor mechanism 210 or otherwise situated with or without a scissor mechanism 210. In some of these embodiments, device 100 comprises a mechanism that locks the position of device 100 to protect against pneumatic or hydraulic pressure removal or failure.

As can be seen in the figures, device 100 has a lifting surface 175. In some embodiments, two or more devices are connected together. In some of these embodiments to or more lifting surfaces 175 are powered by a single lifting source.

In some embodiments, device 100 is portable, adjustably connected to one or more other instances of device 100. In some embodiments, device 100 is permanently or semi-permanently fixed to the floor during use.

In operation, device 100 begins in a closed position. The vehicle to be raised is driven up ramp portion 160 of platform 120 until the wheel position comes to rest on lifting surface 175 of platform 120. For embodiments with an edge around lifting surface 175, the vehicle is also driven up ramp portion 160 with the edges serving as a guide. For embodiments with bumps on the front or back of lifting surface 175, the operator of the vehicle will be able to detect the edge of lifting surface 175 as the vehicle drives up the bump and then drives down the backside of the bump. Similarly, detecting the next bump will signal the operator that the vehicle has reached the end of lifting surface 175. For embodiments in which lifting surface 175 is upwardly curved, the operator will be able to detect the wheels dropping into the curved portion.

After that, the lifting mechanism, such as scissor mechanism 210, is manipulated such that platform 120 raises into the air thereby raising the vehicle. In some embodiments, in which scissor mechanism 210 comprises threaded drive rod 370, threaded drive rod 370 is manipulated. Upon rotation of threaded drive rod 370, the pair of spacers 310 spanned by threaded drive rod 370 are drawn toward each other by the operation of threaded drive rod 370. As threaded drive rod 370 draws the pair of spacers towards each other, scissor mechanism 210 lengthens, pushing between base 110 of device 100 and platform 120, which causes platform 120 to rise—lifting the vehicle. In some embodiments, multiple devices 100 are used substantially simultaneously under two or more wheels of a vehicle at a time. In some cases, the two or more devices 100 are connected such that the distances that the devices lift each wheel are substantially equal, causing the portion of the vehicle being lifted to smoothly raise or lower. As can be seen in the figures, device 100 has a lifting surface 175. In some embodiments, two or more devices are connected together. In some of these embodiments to or more lifting surfaces 175 are powered by a single lifting source.

As platform 120 raises up, the movable optional connection between lifting surface 175 and ramp portion 160 has a construction such that ramp portion 160 may fall away as platform 120 lifts the vehicle. When the operator once again lowers the vehicle, ramp portion 120 automatically slides back in the place helped by gravity.

Depending on the embodiment, device 110 listed vehicle up to 6, 12, 18, 24, 30, or 36 inches. Suitable vehicle weights range from 0 to 20,000 pounds, 0 to 10,000 pounds or 0 to 5000 pounds.

While particular embodiments of the present invention have been shown and described, it will be obvious to those skilled in the art that changes and modifications can be made without departing from the embodiments of this invention in its broader aspects and, therefore, the appended claims are to encompass within their scope all such changes and modifications as fall within the true, intended, explained, disclose, and understood scope and spirit of this invention's multitudinous embodiments and alternative descriptions.

Additionally, various embodiments have been described above. For convenience's sake, combinations of aspects composing invention embodiments have been listed in such a way that one of ordinary skill in the art may read them exclusive of each other when they are not necessarily intended to be exclusive. But a recitation of an aspect for one embodiment is meant to disclose its use in all embodiments in which that aspect can be incorporated without undue experimentation. In like manner, a recitation of an aspect as composing part of an embodiment is a tacit recognition that a supplementary embodiment exists that specifically excludes that aspect. All patents, test procedures, and other documents cited in this specification are fully incorporated by reference to the extent that this material is consistent with this specification and for all jurisdictions in which such incorporation is permitted.

Moreover, some embodiments recite ranges. When this is done, it is meant to disclose the ranges as a range, and to disclose each and every point within the range, including end points. For those embodiments that disclose a specific value or condition for an aspect, supplementary embodiments exist that are otherwise identical, but that specifically exclude the value or the conditions for the aspect.

Finally, headings are for the convenience of the reader and do not alter the meaning or content of the disclosure or the scope of the claims.

1. A device comprising
a ramp portion and
a raising portion
wherein the device acts on one wheel of a vehicle and is adapted to raise at least a portion of the vehicle off of the ground.

2. The device of claim 1 wherein the raising portion comprises a pneumatic actuator.

3. The device of claim 2 wherein the raising portion further comprises a scissor mechanism.

4. The device of claim 1 wherein the raising portion comprises a hydraulic actuator.

5. The device of claim 4 wherein the raising portion further comprises a scissor mechanism.

6. The device of claim I wherein the raising portion further comprises a scissor mechanism.

7. The device of claim 6 wherein the scissor mechanism comprises a plurality of scissor moieties connected with a plurality of spacing rods mounted between the scissor moieties.

8. The device of claim 7 wherein two spacing rods located at an end of the scissor mechanisms contain threaded holes perpendicular to the major axis of the spacing rods;
wherein the threaded holes are arranged such that a threaded rod engages both threaded holes.

9. The device of claim 8 further comprising a motor connected to the threaded rod.

10. (canceled)

11. A device comprising
a ramp portion and
a raising portion
wherein the device acts on one wheel of a vehicle and is adapted to raise at least a portion of the vehicle off of the ground;
wherein the raising portion further comprises a scissor mechanism;
wherein the scissor mechanism comprises a plurality of scissor moieties connected with a plurality of spacing rods mounted between the scissor moieties.

12. The device of claim 11 comprising
a ramp portion and
a raising portion
wherein the device acts on one wheel of a vehicle and is adapted to raise at least a portion of the vehicle off of the ground;
wherein the raising portion further comprises a scissor mechanism;
wherein the scissor mechanism comprises a plurality of scissor moieties connected with a plurality of spacing rods mounted between the scissor moieties;
wherein two spacing rods located at an end of the scissor mechanisms contain threaded holes perpendicular to the major axis of the spacing rods;
wherein the threaded holes are arranged such that a threaded rod engages both threaded holes;
wherein an end of the threaded rod connects to a motor.

13. The device of claim 12 wherein, the motor uses 1.20 VAC, 12 VDC, or 24 VDC.

14. A device comprising
two or more ramp portions and
two or more raising portions
wherein the device acts on one wheel of a vehicle and is adapted to raise at least a portion of the vehicle off of the ground; and
wherein the raising portions are connected such that the raising portions rise substantially at the same rate.

15. The device of claim 14 wherein at least one raising portion comprises a pneumatic actuator.

16. The device of claim 14 wherein at least one raising portion comprises a hydraulic actuator.

17. The device of claim 16 wherein at east one raising portion comprises a scissor mechanism.

18. The device of claim 17 wherein at least one scissor mechanism comprises a plurality of scissor moieties connected with a plurality of spacing rods mounted between the scissor moieties.

19. The device of claim 18 wherein two spacing rods located at an end of the scissor mechanisms contain threaded holes perpendicular to the major axis of the spacing rods;
wherein the threaded holes are arranged such that a threaded rod engages both threaded holes.

20. The device of claim 19 further comprising a motor connected to the threaded rod.

21. The device of claim 1 further adapted to provide access to the undercarriage of the vehicle.
